(19) United States
(12) Patent Application Publication
(10) Pub. No.: US 2019/0034745 A1
(43) Pub. Date: Jan. 31, 2019

(54) INFORMATION PROCESSING MODULE, INFORMATION PROCESSING METHOD, INFORMATION PROCESSING PROGRAM, AND INFORMATION PROCESSING APPARATUS

(71) Applicants: REVO Inc., Kanagawa (JP); IPC Inc., Tokyo (JP)

(72) Inventors: Shigehito Kuma, Kanagawa (JP); Hiroaki Yamauchi, Tokyo (JP)

(73) Assignees: REVO Inc., Kanagawa (JP); IPC Inc., Tokyo (JP)

(21) Appl. No.: 15/878,360

(22) Filed: Jan. 23, 2018

(30) Foreign Application Priority Data
Jan. 23, 2017 (JP) 2017-009216

(51) Int. Cl. G06K 9/00; G06T 3/40

(52) U.S. Cl. CPC G06K 9/00892; G06T 3/4015; G06K 9/00899; G06K 2009/00966; G06K 2009/00953

(57) ABSTRACT

To provide an imaging apparatus including an image processor that processes a fingerprint portion or the like that can be used for at least biometrics authentication of image data based on a digital imaging signal output from an image sensor into an unverifiable state with a template for biometrics authentication.

### TECHNICAL FIELD

The present invention relates to an information processing module, an information processing method, an information processing program, and an information processing apparatus, and in particular, relates to an information processing module that processes a high-resolution image, an information processing method, an information processing program, and an information processing apparatus.

### RELATED ART

Sankei News “Fingerprints are targeted on networks! Hand images in danger of abuse . . . National Institute of Informatics aims to put new technology into practical use (Jan. 9, 2017)” reports that it is possible to read fingerprints from images posted on homepages and the like and abuse the fingerprints as personal information. With a vast amount of images posted on the Internet due to widespread use of smartphones, abuse risks of personal information are on the rise. If your fingerprints are read from an image by third parties, there are risks of privacy invasion or monetary damage and more caution will be needed in the future in which information technology makes more progress.

### SUMMARY

However, as described above, the speed at which the resolution of cameras and displays improves is so fast and adequate countermeasures have not been taken to effectively prevent reading fingerprints from an image and abusing the fingerprints as personal information.

As is evident from the presence of body portions other than fingerprints for which biometrics authentication can be performed, objects that may be abused as personal information are not limited to fingerprints read from an image. Thus, countermeasures against abuse should be taken comprehensively for all body portions for which biometrics authentication can be performed.

Therefore, an object of the present invention is to prevent information used for biometrics authentication that can be read from an image or the like from being abused.

To solve the above object, an information processing module according to the present invention includes a processing unit that processes a portion of information to be processed that can be used for at least biometrics authentication into an unverifiable state with a template for biometrics authentication.

Also, an information processing method according to the present invention includes a step of processing a portion of information to be processed that can be used for at least biometrics authentication into an unverifiable state with a template for biometrics authentication.

Further, an information processing program according to the present invention causes an information processing apparatus to execute the information processing method.

Further, an information processing apparatus according to the present invention includes the information processing module.

As the information processing apparatus, imaging apparatuses such as digital cameras, video cameras including portable camcorders, and mobile phones or smartphones with a camera, displays, digital TV sets, DVD recorders/players, personal computers, and printers can be cited. Incidentally, as the information that can be used for biometrics authentication, fingerprints, palm shapes, faces, retinas, irises, ears, blood vessels, lip movement, winking, walking, handwriting, voices, and key strokes can be cited.

### BRIEF DESCRIPTION OF DRAWINGS

FIG. 1 is a block diagram showing the configuration of an imaging apparatus according to a first embodiment of the present invention;

FIG. 2 is a diagram showing processing object examples of image data by an image processor shown in FIG. 1;

FIG. 3 is a diagram showing states of a fingerprint portion of image data before and after processing by the image processor shown in FIG. 1; and

FIG. 4 is a diagram showing an operation example of the image processor when processing shown in the Reference symbol G of FIG. 3 is performed.

### DETAILED DESCRIPTION

Hereinafter, an embodiment to carry out the present invention will be described with reference to the drawings.

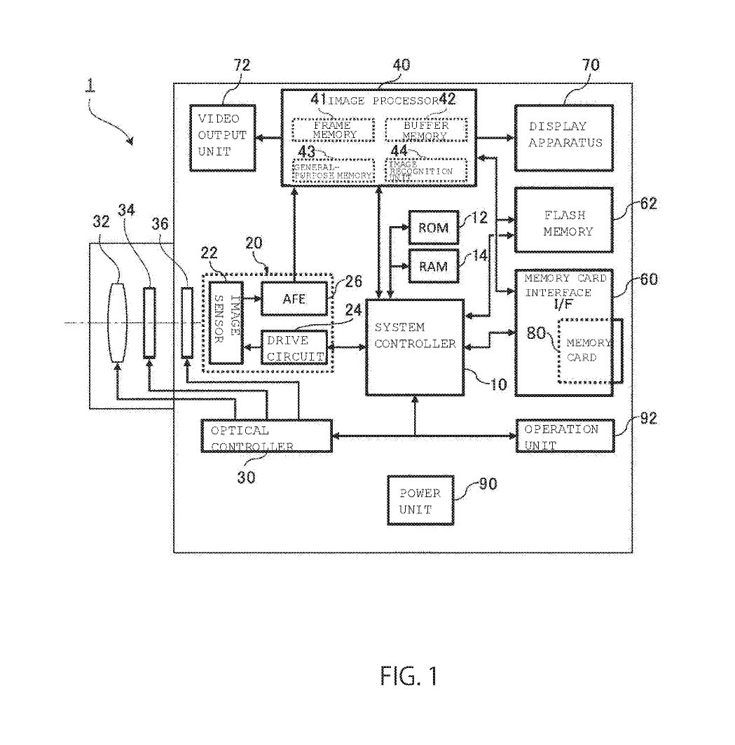

FIG. 1 is a block diagram showing a schematic configuration of an imaging apparatus 1 (video camera) as an information processing apparatus according to an embodiment of the present invention. The imaging apparatus 1 is roughly divided into a system controller 10, an imaging unit 20, a taking lens 32, an image processor 40, a flash memory 62, a display apparatus 70, and a video output unit 72 described below.

The system controller 10 controls an overall operation of the imaging apparatus 1 and includes a processor such as central processing unit (CPU) or digital signal processor (DSP). After power is supplied from a power unit 90, the system controller 10 is used to exercise overall control of the imaging apparatus 1 by executing a control program after accessing a read only memory (ROM) 12 to read the control program that implements various operations and to load the control program into a random access memory (RAM) 14 of a work area or the like.

The imaging unit 20 includes an image sensor 22, a drive circuit 24, and an analog front-end (AFE) 26 described below. The image sensor 22 is constituted of charge coupled device (CCD) or complementary metal oxide semiconductor (CMOS) selectively mounted with a color filter and after an optical signal from a subject is input, is used to output the analog imaging signal corresponding to the signal. The drive circuit 24 is used to supply a drive signal that controls output and the like of an analog imaging signal to the image sensor 22. The AFE 26 is used to generate a digital imaging signal by performing processes such as removal of reset noise by correlated double sampling (CDS), automatic gain control, and analog-digital conversion on an analog imaging signal output from the image sensor 22.

Regarding an optical system, the taking lens 32 is, for example, a zoom lens constituted of a plurality of optical lenses having an auto-focus function, an optical filter and the like and is used to capture an optical signal from a subject. A diaphragm 34 is in charge of adjusting an amount of light captured into the imaging apparatus 1 through the taking lens 32 and making focus adjustments. A shutter 36 is used to secure a proper exposure together with the diaphragm 34. An optical controller 30 is used to control an operation with the taking lens 32, the diaphragm 34, and the shutter 36.

The image processor 40 is used to generate image data by performing signal processes like, as is known, clamping, defect corrections, demosaic processing, sharpness, brightness corrections, linear matrix processing, white balance, contour corrections, gamma corrections, Y/C separation, and color difference corrections on a digital imaging signal after the digital imaging signal output from the AFE 26 of the imaging unit 20 is input. Then, the image processor 40 is used to sequentially store each piece of generated image data in a frame memory 41 in units of frames, to read each piece of image data at predetermined timing, to compress the image data in a predetermined format such as moving picture experts group 4 (MPEG4), and to store the image data in a buffer memory 42 in units of PES (Packetized Elementary Stream) packets, movie fragments or the like.

Also, the image processor 40 is used to access and store compressed image data stored in the buffer memory 42 in a memory card 80 that can be inserted into or removed from a memory card interface (I/F) 60 or a flash memory 62 via the memory card interface (I/F) 60.

Further, when instructed to play back a photographed image by the user through an operation unit 92, the image processor 40 is used to read the specified image data from the memory card 80 or the flash memory 62 and convert the image data into a video signal in a predetermined format to output the image data to the display apparatus 70 or the video output unit 72.

Here, the image processor 40 is used to process a portion that can be used for at least biometrics authentication of a digital imaging signal output from the AFE 26 or image data based on the digital imaging signal into an unverifiable state with a template for biometrics authentication. In other words, the imaging apparatus 1 according to the present embodiment includes an information processing module that implements the above operation. Hereinafter, a case in which image data is processed is taken as an example.

### (1) Processing Area

A processing area of image data may be the entire image data, but is at least a fingerprint portion that can be used for biometrics authentication. That is, the processing area of image data includes

[a] entire image data,

[b] only a fingerprint portion of image data,

[c] a part of the fingerprint portion (for example, a feature point), and

[d] the fingerprint portion and a peripheral area thereof.

Each of the above processing areas has advantages described below and thus, the user may be allowed to select one of the processing areas.

[a] When the entire image data is processed, there is an advantage of being able to eliminate an image recognition process to identify the processing area.

[b] When only a fingerprint portion of image data is processed, only the small processing area is required and thus, loads by processing can advantageously be reduced. Particularly, this is suitable when image data is still image data.

[c] When a part of the fingerprint area is processed, loads by processing can advantageously be reduced still more than in [b]. Particularly, this is suitable when it is difficult to secure the processing time like when a live TV program is shot by a TV program recording video camera.

[d] When the fingerprint portion and a peripheral area thereof are processed, the image recognition process can be performed while thinning out the process by processing a periphery of the portion including the portion processed last time if there is no large difference between image data to be processed like still image data shot continuously or frame image data of moving image data.

In addition to the fingerprint portion, portions that can be used for biometrics authentication include a palm shape portion, a face portion, a retina portion, an iris portion, an ear portion, a blood vessel portion, a lip movement portion, a winking portion, a walking portion, a handwriting portion, a voice portion, and a key stroke portion.

### (2) Processing Method

As a processing method,

[a] When the entire image data is processed, for example, changing a portion of about a few % to 10% distributed substantially uniformly as a whole of the entire image data to a black level of about 100% intentionally or creating a state that is the same as a defective pixel so that feature points such as fingerprints read from an image cannot be recognized is included.

[b] When a part of image data is processed, when a fingerprint portion of image data is processed, performing a rotation process of data of a pixel group corresponding to the portion in a spiral fashion, interchanging the data randomly, or substituting a black level of about 100% or an artificially created fingerprint image is included. Incidentally, processing here includes not making defect corrections when image data contains any pixel defect. In addition, to avoid reading fingerprints from an image and abusing the fingerprints as personal information more strictly, irreversible processing is preferable.

### (3) Processing Level

The processing level of image data is to process into at least a state in which the image data cannot be collated with a template for biometrics authentication. More specifically, if fingerprints are read from an image based on processed image data by a fingerprint authentication sensor and the fingerprints are collated with a registered template, the fingerprints and the template only need to be unverifiable.

The unverifiable state here is a state in which the false acceptance rate is equal to normal biometrics authentication or less. In general, the false acceptance rate is about 0.001% or less for fingerprints, about 0.15% or less for palm shapes, about 3% or less for faces, about 0.001% or less for irises, about 0.0001% or less for blood vessels (veins), about 3% or less for handwriting, and about 5% or less for voices and processing may be performed such that these conditions are satisfied. Normally, it is easy to satisfy the conditions by making feature points of a fingerprint portion different.

For example, a high-resolution camera can obtain valuable high-resolution images and thus, processing like lowering resolution is not considered to be preferable. On the other hand, even if fingerprints and the like of an image are processed, actual damage rarely occurs. Also, an image based on image data in which only a feature point is changed is normally unverifiable when collated with a template even if the processing is unrecognizable to human eyes. Further, biometrics authentication is naturally used alone, but is frequently combined with other authentication and thus, processing such as substitution with non-existent artificial image data can be also performed.

### (4) Processing Time

The processing time of image data is, for example,

[a] in parallel with clamping or the like (for example, between clamping and a demosaic process),

[b] after clamping and before compression into a format such as MPEG4, or

[c] after decompression of image data until output to the display apparatus 70 or the like.

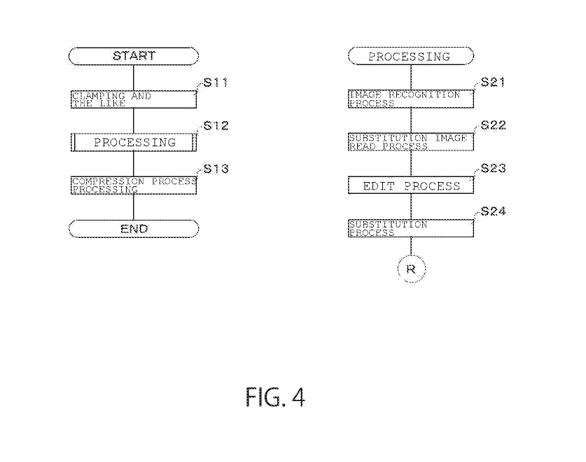

Each of the above processing times has advantages described below and thus, the user may be allowed to select timing for the processing.

[a] When processing is performed in parallel with clamping, for example, a spare time between clamping and the demosaic process can effectively be used. To implement this processing time, step S11 and step S12 in FIG. 4 described below may be executed in parallel.

[b] When processing is performed after clamping and before compression into a format such as MPEG4, a space time between storage and compression of image data in the frame memory 41 can effectively be used. To implement this processing time, processing may be performed in the order shown in FIG. 4 described below.

[c] When processing is performed after decompression of image data until output to the display apparatus 70 or the like, there are generally more matters to be processed in the time between recording start instructions of image data and actual recordings than in the time between playback start instructions of image data and actual playback and thus, a situation in which processing needs to be performed during recording of image data in which there is relatively limited time can be avoided. To implement this processing time, the order of step S12 and step S13 in FIG. 4 described below may be interchanged.

In a general-purpose memory 43, a program and information needed to perform the above processing are stored. The image processor 40 performs the above processing based on information stored in the general-purpose memory 43 through cooperation of a program stored in the general-purpose memory 43 and a CPU (not shown). In this case, before starting processing, a processing area may be determined by performing fingerprint detection or the like from a digital imaging signal or image data through an image recognition unit 44.

The display apparatus 70 is a liquid crystal display (LCD), an organic electroluminescence display (OELD) or the like that also functions as what is called a viewfinder and displays a photographed image of a subject on a display screen based on an image signal input from the image processor 40.

The video output unit 72 is used to output a video signal output from the image processor 40 to an external display (not shown) or the like by being connected to a display apparatus such as the external display, a video apparatus, a personal computer, or a printer by wire or by wireless.

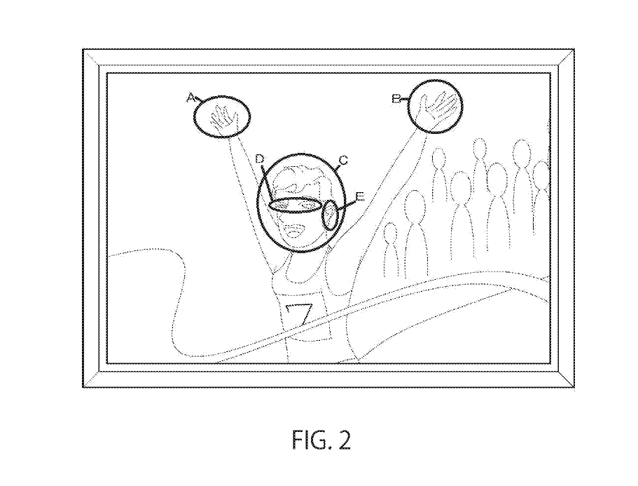

FIG. 2 is a diagram showing processing object examples of image data by the image processor 40 shown in FIG. 1. For an image shown in FIG. 2, an area A to an area E are areas in which information that can be used for biometrics authentication is displayed. As described above, processing may be performed on the entire image shown in FIG. 2, but at least information that can be used for biometrics authentication in the area A to area E should be processed.

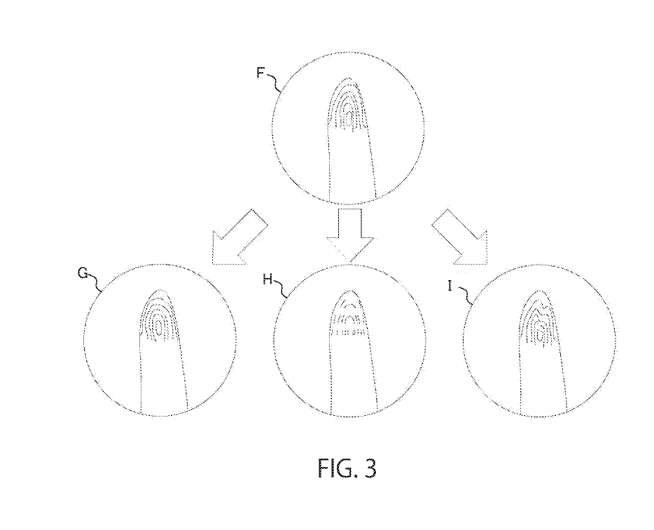

FIG. is a diagram showing states of image data before and after processing by the image processor 40 shown in FIG. 1. The Reference symbol F of FIG. 3 shows an enlarged view of a fingerprint portion of image data before processing and FIG. 3 shows enlarged views of the fingerprint portion of the image data after processing.

The fingerprint portion of the image data shown in the Reference symbol G of FIG. 3 is obtained by substituting artificial image data for the fingerprint portion of the image data shown in the Reference symbol F of FIG. 3. The fingerprint portion of the image data shown in the Reference symbol H of FIG. 3 is obtained by partially masking the fingerprint portion of the image data shown in the Reference symbol F of FIG. 3. The fingerprint portion of the image data shown in the Reference symbol I of FIG. 3 is obtained by changing the position of feature points in the fingerprint portion of the image data shown in the Reference symbol F of FIG. 3.

By performing this type of processing, if an attempt is made to read fingerprints of an image based on processed image data and abuse the fingerprints as personal information, the fingerprints are unverifiable when compared with a template for biometrics authentication and thus cannot be actually abused.

FIG. 4 is a diagram showing an operation example of the image processor 40 when processing shown in the Reference symbol G of FIG. 3 is performed. Here, a case in which moving images are shot by a video camera and processing is performed on image data based on a digital imaging signal thereof is taken as an example.

First, the image processor 40 performs, as is known, clamping or the like on a digital imaging signal output from the AFE 26 of the imaging unit 20 to generate image data and stores the image data in the frame memory 41 (step S11).

Next, the image processor 40 first reads the image data stored in the frame memory 41. Then, the image processor 40 performs processing on a fingerprint portion, which can be used for biometrics authentication, of the image data (step S12).

More specifically, first, the image recognition unit 44 performs an image recognition process such as identifying a fingerprint portion of the image data by separating and extracting feature points of the image data or matching patterns (step S21). When processing is performed on the entire image data, the image recognition process is not needed.

Next, the image processor 40 performs a substitution image read process such as reading artificial image data of fingerprints for substitution shown in the Reference symbol G of FIG. 3 from the general-purpose memory 43 (step S22). In the general-purpose memory 43, one or two or more artificial images of fingerprints for substitution may be stored in advance.

Subsequently, the image processor 40 performs an edit process such as editing the size, angle, hue and the like of artificial image data of fingerprints for substitution read from the general-purpose memory 43 based on the fingerprint portion of the image data before the processing recognized by the image recognition process in step S21 (step S23).

Then, the image processor 40 performs a substitution process such as substituting the artificial image data of fingerprints edited by the edit process in step S23 for the fingerprint portion of the image data before the processing recognized by the image recognition process in step S21 (step S24). In this manner, the processed image data is stored in the frame memory 41 again. If the processing is performed at the time shown in FIG. 4, a spare time between storage of image data in the frame memory 41 and the compression process can effectively be used.

Then, the image processor 40 reads the processed image data obtained by the substitution process in step S24 from the frame memory 41 at predetermined timing and performs a compression process such as compressing the processed image data into a format like MPEG4 (step S13).

As is known, image data on which the compression process is performed is stored in the buffer memory 42. Then, when a predetermined number of frames are stored in the buffer memory 42, the frames are output to the memory card 80 or the like.

To process into image data in the Reference symbol H of FIG. 3, a mask image, in which a part of the image becomes a black level of about 100%, is stored and in step S22, a read process such as reading the mask image is performed. Then, in step S23, the size and the like of the mask image may be edited based on the fingerprint portion of the image data before the processing recognized in step S21.

Also, to process into image data in the Reference symbol I of FIG. 3, instead of step S22 to step S24, a virtual line connecting feature points of the image data separated and extracted in step S21 may be created to perform a data movement process by, for example, assigning predetermined weights to each piece of pixel data near the virtual line.

In the present embodiment, a case in which processing is performed when image data is recorded is taken as an example, but image data may also be processed when played back. For example, when image data stored in the memory card 80 or the like is played back, processing may be performed between decompression of the image data and output thereof to the display apparatus 70 or to an external display via the video output unit 72.

Also in the present embodiment, an example of processing a fingerprint portion has been mainly described, but a retina portion, an iris portion, a palm shape portion, a blood vessel portion, and a face portion may also be processed by a method similar to that of the fingerprint portion.

### Other Embodiments

In the embodiment described above, a video camera is taken as an example of the imaging apparatus 1, which is an information processing apparatus, but the information processing apparatus is not limited to the video camera. Examples of the information processing apparatus include three types of an input type apparatus, an intermediate type apparatus, and an output type apparatus.

### (1) Input Type Apparatus

The video camera described above belongs to this category and, in addition, a still camera, a DVD recorder, and an audio input apparatus such as an IC recorder belong to this category as well. The case of the still camera is almost the same as that of the video camera except that image data is compressed into a format of joint photographic experts group (JPEG). For the DVD recorder, processing may be performed on captured image data. For the audio input apparatus, a case of performing voice print authentication can be cited and processing similar to processing on a fingerprint portion or the like by performing processing of changing the frequency of feature points or the like may be performed.

### (2) Intermediate Type Apparatus

Apparatuses that deal with generated image data belong to this category. A file server and a computer can be cited as examples. By mounting the information processing module as described above on these apparatuses, image data dealt with by the apparatuses can also be processed. For the server in which image data is stored or the computer connected thereto, processing can be performed by providing the information processing module described above on the server or the computer. In this case, steps S21 to S24 shown in FIG. 4 may be executed after decompressing compressed image data stored in the server. Then, the processed data may be compressed and brought back to a file storage area before processing on the server or a display connected to the computer may be caused to display the processed data.

### (3) Output Type Apparatus

This type of apparatuses also deals with generated image data. A display, a digital TV set, a DVD player, and a printer can be cited as examples. By mounting the information processing module as described above also on these apparatuses, image data dealt with by the apparatuses can also be processed. On any of these apparatuses, input image data may be displayed on a local apparatus or a display connected thereto or printed after being processed.

Further, the operation of the imaging apparatus 1 described in the present embodiment can be implemented by hardware, software, or a combination of hardware and software. Also, the information processing method executed by the imaging apparatus 1 can be implemented by hardware, software, or a combination of hardware and software. Here, being implemented by software means being implemented by a program read and executed by the computer.

A program can be stored and supplied to the computer using various types of non-transitory computer readable media. The non-transitory computer readable media include various types of tangible storage media. Examples of the non-transitory computer readable media include magnetic storage media (for example, a flexible disk, magnetic tape, and hard disk drive), magneto-optical storage media (for example, a magneto-optical disk), CD-ROM, CD-R, CD-R/W, and semiconductor memories (for example, mask ROM, PROM (Programmable ROM), EPROM (Erasable PROM), flash ROM, RAM). A program may also be supplied to the computer from various types of transitory computer readable media. Examples of the transitory computer readable media include electric signals, optical signals, and electromagnetic waves. The transitory computer readable media can supply a program to the computer via a wire communication path such as an electric wire or optical fiber or a wireless communication path.

### FIG. 1

10 SYSTEM CONTROLLER
22 IMAGE SENSOR
24 DRIVE CIRCUIT
30 OPTICAL CONTROLLER
40 IMAGE PROCESSOR
41 FRAME MEMORY
42 BUFFER MEMORY
43 GENERAL-PURPOSE MEMORY
44 IMAGE RECOGNITION UNIT
60 MEMORY CARD INTERFACE
62 FLASH MEMORY
70 DISPLAY APPARATUS
72 VIDEO OUTPUT UNIT
80 MEMORY CARD
90 POWER UNIT
92 OPERATION UNIT

### FIG. 4

S11 CLAMPING AND THE LIKE
S12 PROCESSING
S13 COMPRESSION PROCESS
PROCESSING
S21 IMAGE RECOGNITION PROCESS
S22 SUBSTITUTION IMAGE READ PROCESS
S23 EDIT PROCESS
S24 SUBSTITUTION PROCESS

1. An information processing module comprising:
a processing unit that processes a portion of information to be processed that can be used for at least biometrics authentication into an unverifiable state with a template for biometrics authentication.

2. The information processing module according to claim 1, further comprising:
a recognition unit that recognizes the portion.

3. The information processing module according to claim 1, wherein the processing unit processes a periphery of the portion including the portion or all information input by an input unit.

4. The information processing module according to claim 1, wherein the information to be processed is image data or voice data.

5. An information processing method comprising:
processing a portion of information to be processed that can be used for at least biometrics authentication into an unverifiable state with a template for biometrics authentication.

6. An information processing program causing an information processing apparatus to execute the information processing method according to claim 5.

7. An information processing apparatus comprising:
the information processing module according to any one of claim 1.

8. An information processing apparatus comprising:
the information processing module according to any one of claim 2.

9. An information processing apparatus comprising:
the information processing module according to any one of claim 3.

9. An information processing apparatus comprising:
the information processing module according to any one of claim 4.
